(19) United States
(12) Patent Application Publication
(10) Pub. No.: US 2023/0162190 A1
(43) Pub. Date: May 25, 2023

(54) SYSTEM AND METHOD FOR IDENTITY VERIFICATION

(71) Applicant: Eduardo Hadley, Hazel Crest, IL (US)

(72) Inventor: Eduardo Hadley, Hazel Crest, IL (US)

(21) Appl. No.: 17/969,662

(22) Filed: Oct. 19, 2022

Related U.S. Application Data
(60) Provisional application No. 63/237,828, filed on Aug. 27, 2021.

(51) Int. Cl. G06Q 20/40; G06K 7/14; G06Q 20/32

(52) U.S. Cl. CPC G06Q 20/4014; G06K 7/1413; G06Q 20/325

(57) ABSTRACT

A system that provides users with an identification scanner security system update and can be used at marijuana dispensaries. A barcode scanner equipped with a light source, a lens, and a sensor can determine a unique identifying code from the barcode and pulls data from a database memory at a remote server in wireless communication with the barcode scanner. An alert to the use of a commercial driving license at the marijuana dispensary can be generated.

### CROSS-REFERENCE TO RELATED APPLICATIONS

This application claims priority from a U.S. Provisional Patent Appl. No. 63/237,828 filed on Aug. 27, 2021, which is incorporated herein by reference in its entirety.

### FIELD OF INVENTION

The present invention relates to a system and method for identity verification, and more particularly, the present invention relates to a system and method for verifying identity at marijuana dispensaries.

### BACKGROUND

Commercial driver licenses may be used illegally in marijuana dispensaries for age verification purposes. Businesses may lack the means to properly vet people for their age when purchasing items like medical marijuana.

A need is therefore appreciated for a system and method that prevent misrepresentation of identity and age.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for verifying an identity of a person.

It is another object of the present invention that fraud and identity misrepresentation can be prevented.

It is another object of the present invention that the method is easy to use.

It is still another object of the present invention that the system and method can be easily and economically implemented at a large scale.

In one aspect, the present invention provides users with an identification scanner security system update. Identification Verification is commonly used to identify a person prior to purchasing items like medical marijuana, Alcoholic beverages, Cigarettes, etc. The disclosed system features a barcode scanner equipped with a light source, a lens, and a sensor designed to determine a unique identifying code from the barcode and pulls data from a database memory at a remote server in wireless communication with the barcode scanner. Further, the system includes multiple security cohorts that allow or restrict the purchase of government related goods based on restrictions like criminal history, age, profession, etc. while improving security when purchasing restricted goods.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram of a system, according to an exemplary embodiment of the present invention.

FIG. 2 shows a custom graphic related to a software, according to an exemplary embodiment of the present invention.

FIG. 3 shows another custom graphic related to the software, according to an exemplary embodiment of the present invention.

FIG. 4 shows another custom graphic related to the software, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

Disclosed is a multipurpose identification scanner security system update invention idea. The disclosed security system may include a barcode scanning device equipped with a light source, a lens, and a light sensor. The light source may be illuminated upon a barcode such that the light reflected from the barcode is received through the lens at the light sensor to determine the unique identifying code from the barcode. The update will allow an alert to the usage of CDL identification cards. The barcode may reside upon an identification card as normal and each unique identifying code from several identification cards may be stored in physical computer memory at a remote server in wireless communication with the barcode scanning device. Each identification card may be associated with one or more security cohorts. The one or more security cohorts may allow or restrict the purchase of various government-regulated goods such as recreational marijuana and medical marijuana, for example, has its own patient card, and recreational marijuana sale goods require proof of age verification. These restrictions may be based upon government regulations and in addition, the update software invention idea stated in this patent specification.

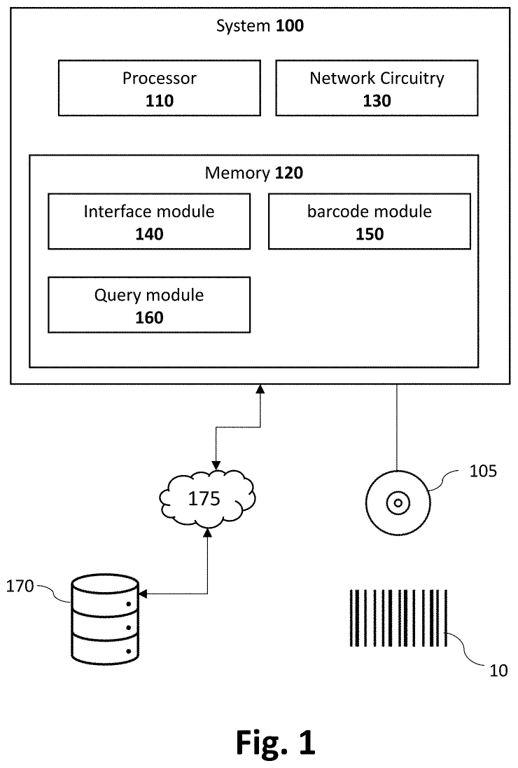

Referring to FIG. 1 is a block diagram illustrating an exemplary embodiment of the present invention. The disclosed system 100 includes a processor 110 and a memory 120. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The system 100 can further include network circuitry that 130 allows the disclosed system to connect to an external network, such as network 175.

The disclosed system 100 can include a barcode scanner 105 which includes a light source, a lens, and a light sensor. The barcode scanner can scan a barcode 10. The memory of the disclosed system includes an interface module 140 that upon execution by the processor 110 can provide an interface for interacting with the disclosed system. An implementation of the interface allows a user to scan a barcode and view an associated record for identity verification and viewing other facts.

The memory 120 can further include a barcode scanning module 150 that can cause the can receive the unique identifying code from the bar code scanner 105.

Memory 120 can further include a query module 160 that can fetch a record associated with a unique code from a database of an external server 170 through a wireless network 175.

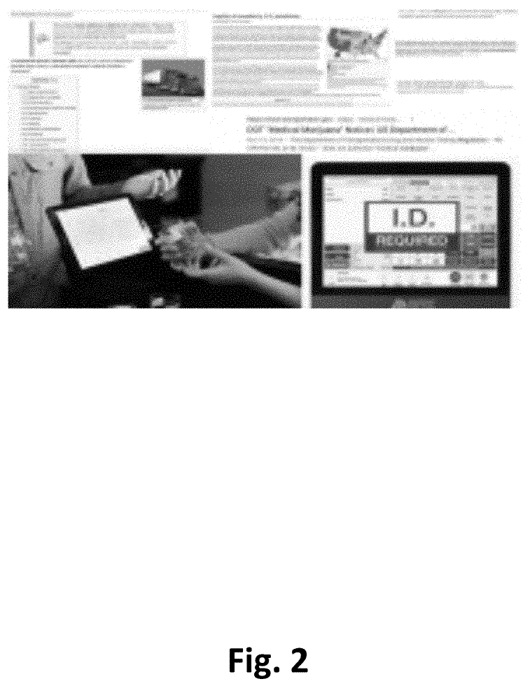

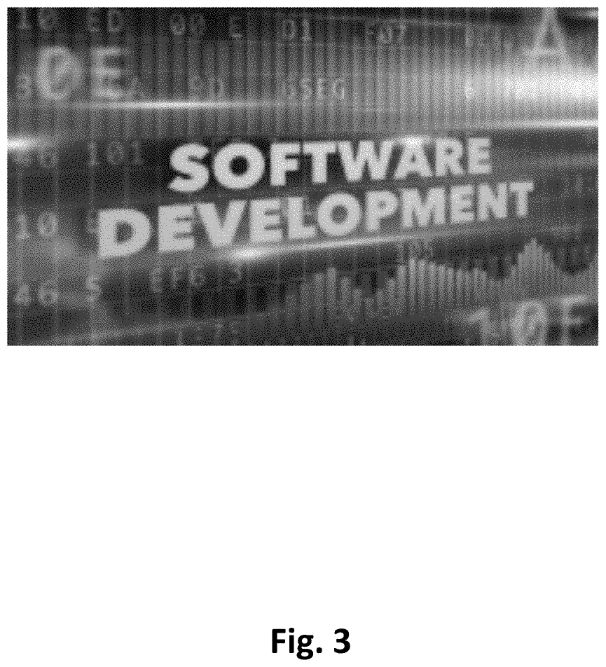

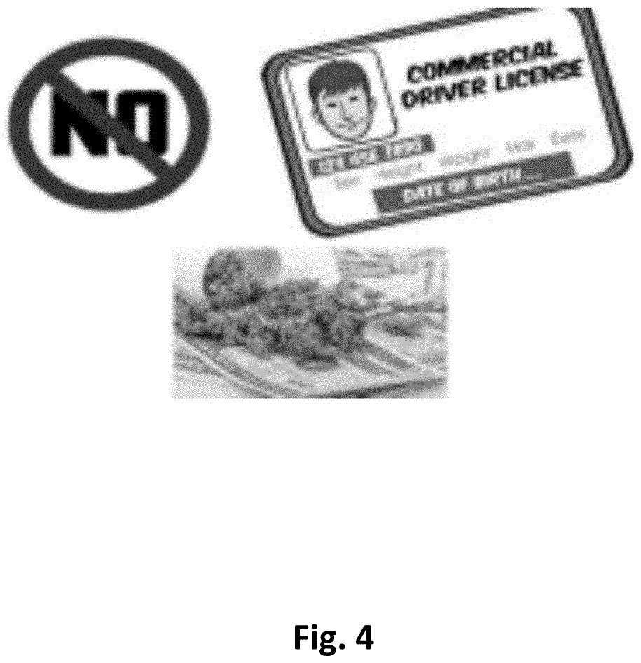

FIGS. 2-4 show various custom graphics related to software.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for use in marijuana dispensaries for verifying an age, the system comprises:
a barcode sensor that comprises a light source, a lens, and a light sensor, wherein the light source is configured to illuminate a barcode, and the light sensor is configured to receive reflected light from the barcode through the lens for reading unique identifying code from the barcode;
wherein the system is configured to implement a method comprising:
fetching data stored pulls data on a database memory at a remote server based on the unique identifying code.

2. The system according to claim 1, wherein the system communicates with the remote server through a wireless connection.

3. The system according to claim 1, wherein the method further comprises:
fetching security cohorts that allow or restrict the purchase of government related goods based on restrictions like criminal history, age, profession, etc.

4. A method for verifying age, the method implemented with a system comprising a barcode scanner, the barcode sensor comprises a light source, a lens, and a light sensor, wherein the light source is configured to illuminate a barcode, and the light sensor is configured to receive reflected light from the barcode through the lens for reading unique identifying code from the barcode, the method comprises:
reading, by the barcode scanner, a unique identifying code; and
fetching data from an external database on a remote server using the unique identifying code, wherein the data is used for age verification.

5. The method according to claim 4, wherein the system communicates with the remote server through a wireless connection.

6. The method according to claim 4, wherein the method further comprises:
fetching security cohorts that allow or restrict the purchase of government related goods based on restrictions like criminal history, age, profession, etc.
